(19) United States
(12) Patent Application Publication
(10) Pub. No.: US 2017/0192098 A1
(43) Pub. Date: Jul. 6, 2017

(54) APPARATUS AND METHOD FOR IONOSPHERIC ANOMALY MONITORING USING KULLBACK-LEIBLER DIVERGENCE METRIC FOR GBAS

(71) Applicants: Jeongho Cho, Daejeon (KR); Hanseo University Academic Cooperation Foundation, Seonsan-si (KR)

(72) Inventor: Jeongho CHO, Daejeon (KR)

(21) Appl. No.: 15/071,899

(22) Filed: Mar. 16, 2016

(30) Foreign Application Priority Data
Dec. 30, 2015 (KR) 10-2015-0189151

(51) Int. Cl. G01S 19/07

(52) U.S. Cl. CPC G01S 19/07

(57) ABSTRACT

Provided is an apparatus for monitoring an ionospheric anomaly using a Kullback-Leibler divergence (KLD) metric based on a ground-based augmentation system (GBAS) ground system. The ionospheric anomaly monitoring apparatus includes a filter configured to embed a pseudo range measurement value and a carrier-phase measurement value measured at the GBAS, and to provide a KLD metric; and a determiner configured to determine a presence or an absence of the ionospheric anomaly using the KLD metric for GBA.

### CROSS-REFERENCE TO RELATED APPLICATION(S)

This application claims the benefit under 35 USC 119(a) of Korean Patent Application No. 10-2015-0189151 filed on Dec. 30, 2015, in the Korean Intellectual Property Office, the entire disclosure of which is incorporated herein by reference for all purposes.

### FIELD OF THE INVENTION

Example embodiments relate to an ionospheric anomaly monitoring apparatus for a ground-based augmentation system (GBAS), and more particularly, to an apparatus and method for monitoring an ionospheric anomaly using a Kullback-Leibler divergence (KLD) metric for GBAS.

### DESCRIPTION OF THE RELATED ART

A ground-based augmentation system (GBAS) has been developed for precise approaches and landings of aircrafts. For its application to actual aviation operations, the GBAS needs to meet the requirements specified in the International Civil Aviation Organization (ICAO).

In general, the requirements for the performance of a GBAS may include precision, integrity, continuity, and availability. Here, the integrity performance refers to an ability capable of removing a malfunction or an anomaly within an appropriate period of time or timely alerting a user in response to the occurrence of the malfunction or the anomaly. As such, the integrity performance directly affects the safety of an aircraft and thus, is a top-priority condition to be considered.

A cause that does not satisfy the integrity performance is defined as an integrity threat. The integrity threat to be considered in the GBAS may include an ionospheric storm, a signal deformation, a decrease in signal strength, a code-carrier divergence (CCD), an excessive change in a pseudorange, an orbit information error, and the like. In the GBAS for providing a GBAS approach service type (GAST)-C service, a reference station serves to monitor the integrity. Thus, there is a need to employ a monitoring technique for detecting and eliminating an integrity threat of a level capable of affecting the safety of an aircraft. Further, whether the corresponding integrity threat is appropriately eliminated by way of the monitoring technique is to be proved.

In the GBAS according to the related art, a CCD test installed to monitor the integrity may configure a metric based on a rate of change in a difference between a pseudorange and a carrier-phase measurement value measured at a receiver. Accordingly, a CCD phenomenon caused by an anomalous satellite signal or an ionospheric storm may be detected.

In general, a global positioning system (GPS) navigation equation may be represented using a pseudo range ρₖ and a carrier phase φₖ according to Equation 1.

ρₖ=rₖ+bₖ^{u}−Bₖ^{s}+Iₖ+Tₖ+Mₖ+εₖ^{ρ}

φₖ=rₖ+bₖ^{u}−Bₖ^{s}−Iₖ+Tₖ+Nλ+εₖ^{φ} [Equation 1]

To satisfy a current GBAS CAT-I standard, the metric of the CCD test uses a primary or secondary infinite impulse response (IIR) filter. However, GBAS in Category (CAT)-II/III is required for a next generation GBAS. To this end, the performance of a primary or secondary filter is required to be enhanced in order to secure a faster time to alarm (TTA).

The conventional GBAS CAT-1 CCD metric Jₖ may be represented as Equation 2. Further, a configuration of the primary IIR filter and the secondary IIR filter of the GBAS CAT-I CCD metric may be represented as Equation 3 and Equation 4, respectively.

$$\begin{matrix}{J}_{k} = \frac{τ - {T}_{s}}{τ} {J}_{k - 1} + \frac{{T}_{s}}{τ} ( {d}_{k} - {d}_{k - 1} ) & [ Equation 2 ] \\ {J}_{k}^{1} = \frac{{τ}_{1} - {T}_{s}}{{τ}_{1}} {J}_{k - 1}^{1} + \frac{{T}_{s}}{{τ}_{1}} ( {d}_{k} - {d}_{k - 1} ) & [ Equation 3 ] \\ {J}_{k}^{2} = \frac{{τ}_{2} - {T}_{s}}{{τ}_{2}} {J}_{k - 1}^{2} + \frac{{T}_{s}}{{τ}_{2}} {J}_{k}^{1} & [ Equation 4 ]\end{matrix}$$

In Equation 2 and Equation 3, τ denotes a time constant of a filter, Tₛ denotes a measurement sampling time, and dₖ denotes a difference between the pseudo range measurement value and the carrier-phase measurement value, and may be represented as Equation 5.

dₖ=ρₖ−φₖ=2Iₖ+Mₖ−Nλ

dₖ−dₖ₋₁=2(Iₖ−Iₖ₋₁)+(Mₖ−Mₖ₋₁). [Equation 5]

In Equation 5, Mₖ denotes a multipath error and Iₖ denotes an ionospheric delay value. A high frequency component may be attenuated through the IIR filter and only a change in the ionospheric delay value Iₖ may remain.

As described above, the CCD metric to satisfy the current GBAS CAT-I employs the primary or secondary IIR filter, whereas CAT-II/III is required for the next generation GBAS. To meet the requirements, there is a need for an ionospheric anomaly monitoring apparatus and method capable of securing a faster TTA.

### SUMMARY OF THE INVENTION

Example embodiments provide an ionospheric anomaly monitoring apparatus and method that may detect and eliminate an integrity threat of a level capable of affecting the safety of an aircraft.

Example embodiments also provide an ionospheric anomaly monitoring apparatus and method that may match a ground-based augmentation system (GBAS) in Category (CAT)-II/III service standard according to requirements of an International Civil Aviation Organization (ICAO) standard of a GBAS.

Example embodiments also provide an ionospheric anomaly monitoring apparatus and method that may provide a relatively enhanced time-to-flag for detecting an ionospheric anomaly compared to a code-carrier divergence (CCD) test.

According to an aspect of example embodiments, there is provided an apparatus for monitoring an ionospheric anomaly for GBAS, the apparatus including a filter configured to embed a pseudo range measurement value and a carrier-phase measurement value measured at the GBAS, and to provide a Kullback-Leibler divergence (KLD) metric; and a determiner configured to determine a presence or an absence of the ionospheric anomaly using the KLD metric based on the GBAS.

The filter may be an auto-regressive moving average (ARMA) filter.

The KLD metric may match a CAT-II/III service standard according to requirements of an ICAO standard of the GBAS.

The determiner may be further configured to compare a detection threshold and the KLD metric, and to determine the KLD metric as an anomalous signal in response to the KLD metric being greater than the detection threshold.

The filter may be further configured to phase-shift the embedded pseudo range measurement value and carrier-phase measurement value according to Equation 6 and Equation 7, and to calculate a KLD value based on the phase-shifted pseudo range measurement value and carrier-phase measurement value according to Equation 8.

$$\begin{matrix}{ξ}_{ρ , k} = {[ {ρ}_{k} , {ρ}_{k - {T}_{s}} , … , {ρ}_{k - ( L - 1 ) {T}_{s}} ]}^{T} ∈ Γ ⋐ {L}^{} & [ Equation 6 ] \\ {ξ}_{φ , k} = {[ {φ}_{k} , {φ}_{k - {T}_{s}} , … , {φ}_{k - ( L - 1 ) {T}_{s}} ]}^{T} ∈ Θ ⋐ {L}^{} , and & [ Equation 7 ] \\ {J}_{k}^{3} = \sum f ( {ξ}_{ρ , k} ) log \frac{f ( {ξ}_{ρ , k} )}{g ( {ξ}_{φ , k} )} , & [ Equation 8 ]\end{matrix}$$

Here, ρₖ denotes a pseudo range, φₖ denotes a carrier-phase, ξ_{ρ,k} denotes the phase-shifted pseudo range, ξ_{φ,k} denotes the phase-shifted carrier-phase measurement value, and Jₖ³ denotes the KLD value.

The KLD metric may be obtained according to Equation 10.

$${J}_{k}^{4} = \frac{{τ}_{KLD} - {T}_{s}}{{τ}_{KLD}} {J}_{k - 1}^{4} + \frac{{T}_{s}}{{τ}_{KLD}} ( {J}_{k}^{3} - {J}_{k - 1}^{3} ) . \qquad [ Equation 10 ]$$

The detection threshold may be obtained according to Equation 11.

T(el)=μ(el)±K_{ffd}·INF·σ(el) [Equation 11]

In Equation 11, μ(x) denotes the mean of the KLD metric Jₖ⁴ when an elevation angle is x, σ(x) denotes the standard deviation of the KLD metric when the elevation angle is x, INF denotes an inflation factor based on a heavy-tailed distribution of the KLD metric, el denotes the elevation angle, K_{ffd} and denotes a constant and may be represented as Equation 12.

K_{ffd}=Q⁻¹(1−P_{FA}/2) [Equation 12]

In Equation 12, Q⁻¹(•) denotes a reverse function of accumulative probability distribution of a normal distribution.

According to another aspect of example embodiments, there is provided a method of monitoring an ionospheric anomaly for GBAS, the method including embedding a pseudo range measurement value and a carrier-phase measurement value measured at the GBAS, and provide a KLD metric; and determining a presence or an absence of the ionospheric anomaly using the KLD metric based on the GBAS.

The providing of the KLD metric may include using an ARMA filter, and the KLD metric may match a CAT-II/III service standard according to requirements of an ICAO standard of the GBAS.

The determining of the presence or the absence of the ionospheric anomaly may include comparing a detection threshold and the KLD metric, and determining the KLD metric as an anomalous signal in response to the KLD metric being greater than the detection threshold.

According to still another aspect of example embodiments, there is provided a non-transitory computer-readable medium storing a program to implement the ionospheric anomaly monitoring method.

An ionospheric anomaly monitoring apparatus and method using a KLD for GBAS according to example embodiments may match a CAT-II/III service standard according to requirements of an ICAO standard of the GBAS and may provide a relatively enhanced time-to-flag for detecting the ionospheric anomaly compared to a CCD anomaly monitoring apparatus and method.

Other features and aspects will be apparent from the following detailed description, the drawings, and the claims.

### BRIEF DESCRIPTION OF DRAWINGS

FIG. 1 is a block diagram illustrating an ionospheric anomaly monitoring apparatus using a Kullback-Leibler divergence (KLD) metric for a ground-based augmentation system (GBAS) ground system according to example embodiments;

FIG. 2 is a flowchart illustrating an ionospheric anomaly monitoring method using a KLD metric for GBAS according to example embodiments;

FIGS. 3A and 3B are graphs showing simulation data, for example, data flows of virtual pseudo range pₖ and carrier-phase qₖ generated by varying a level of applied noise in a time domain according to example embodiments;

FIG. 4A is a graph showing a data distribution before a 1000-th epoch of pk generated in FIG. 3B, and FIG. 4B is a graph showing a data distribution after a 1000-th epoch of pk generated in FIG. 3B according to example embodiments;

FIG. 5A is a graph showing a data distribution before a 1000-th epoch of qk generated in FIG. 3B, and FIG. 5B is a graph showing a data distribution after a 1000-th epoch of qk generated in FIG. 3B according to example embodiments;

FIG. 6 illustrates data flows of metrics measured according to embodiment 1 and comparisons 1 and 2 in a time domain in which measurement was implemented using data provided in FIG. 2A;

FIG. 7 illustrates data flows of metrics measured according to embodiment 1 and comparisons 1 and 2 in a time domain in which measurement was implemented using data provided in FIG. 2B;

FIG. 8 is a graph showing a KLD metric of pseudo range data and carrier-phase data collected based on an elevation angle and a resultant detection threshold according to example embodiments;

FIGS. 9A and 9B are graphs showing a comparison of a case in which an anomalous signal was applied to a number-24 satellite to compare a time-to-flag with respect to an elevation angle; FIG. 9A is a graph showing a case in which the anomalous signal was applied at a rate of 0.02 m/s, and FIG. 9B is a graph showing a case in which the anomalous signal was applied at a rate of 0.01 m/s; and

FIG. 10 is a graph showing a comparison of overall average time-to-flag with respect to all of the satellites having appeared based on collected one-day data when a rate of change in the ionospheric gradient is 0.02 m/s.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION OF THE INVENTION

Hereinafter, example embodiments will be described with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Also, if necessary, some terms may be arbitrarily selected by the applicant to help the understanding and/or to achieve clarity of description. In this case, a meaning of the terms will be given in a corresponding explanation portion. Accordingly, the terms used herein should be understood based on the meaning thereof and the overall description made herein.

In a ground-based augmentation system (GBAS), a reference station serves to monitor integrity. Thus, a monitoring scheme for detecting and eliminating an integrity threat of a level capable of affecting the safety of an aircraft needs to be employed.

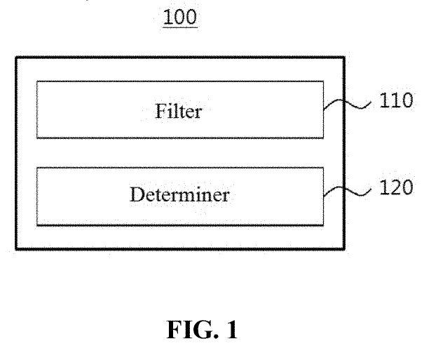

FIG. 1 is a block diagram illustrating an ionospheric anomaly monitoring apparatus (hereinafter, an ionospheric anomaly monitoring apparatus) using a Kullback-Leibler divergence (KLD) metric for GBAS according to example embodiments.

A KLD is a function used to calculate a difference between two probability distributions, and may be used to calculate an information entropy difference that may occur if sampling an ideal distribution by employing another distribution approximate thereto.

According to example embodiments, the ionospheric anomaly monitoring apparatus 100 may include a filter 110 configured to embed a pseudo range measurement value and a carrier-phase measurement value measured at the GBAS, and to provide a KLD metric to a determiner 120, and the determiner 120 configured to determine a presence or an absence of an ionospheric anomaly using the provided KLD metric based on the GBAS.

The filter 110 may embed a global positioning system (GPS) measurement value, and may reconstruct, that is, phase-shift a filter input based on the pseudo range measurement value, the carrier-phase measurement value, and previous measurement values up to an embedding dimension L. Through this, a change in the pseudo range measurement value and the carrier-phase measurement value may be easily verified, which leads to detecting the divergence of two sets of data.

In detail, the filter 110 phase-shifts measurements values of the pseudo range ρₖ and the carrier-phase φₖ into time-delayed versions of measurement vectors. The phase-shifted pseudo range measurement value ξ_{ρ,k} and the phase-shifted carrier-phase measurement value ξ_{φ,k} may be represented as Equation 6 and Equation 7, respectively.

ξ_{ρ,k}=[ρₖ,ρ_{k-T}_{ₛ}, . . . ,ρ_{k-(L-1)T}_{ₛ}]^{T}εΓ⊂ [symbol] ^{L} [Equation 6]

ξ_{φ,k}=[φₖ,φ_{k-T}_{ₛ}, . . . ,φ_{k-(L-1)T}_{ₛ}]^{T}εΘ⊂ [symbol] ^{L}, [Equation 7]

A KLD value Jₖ³ may be obtained based on the phase-shifted pseudo range measurement value ξ_{ρ,k} and carrier-phase measurement values ξ_{φ,k} of Equation 6 and Equation 7, and may be represented as Equation 8.

$${J}_{k}^{3} = \sum f ( {ξ}_{ρ , k} ) log \frac{f ( {ξ}_{ρ , k} )}{g ( {ξ}_{φ , k} )} \qquad [ Equation 8 ]$$

In Equation 8, distributions of the phase-shifted pseudo range measurement value ξ_{ρ,k} carrier-phase measurement values ξ_{φ,k} may be normalized to Σₖξ_{ρ,k}=1 and Σₖξ_{φ,k}=1, respectively. Herein, to enlarge a change that distinguishes the distributions and thereby facilitate an alarm to be triggered, the phase-shifted pseudo range measurement value ξ_{ρ,k} and carrier-phase measurement value ξ_{φ,k} are modified as shown in Equation 9.

ξ_{ρ,k}=ξ_{ρ,k}/Σᵢξ_{ρ,i},ξ_{φ,k}=ξ_{φ,k}/Σᵢξ_{ρ,i} [Equation 9]

As described above, according to example embodiments, the KLD metric may be used to detect an occurrence of an anomalous change in a shape of a distribution of a reconstructed or phase-shifted input space.

The KLD value Jₖ³ calculated according to Equation 8 is passed through an auto-regressive moving average (ARMA) filter. This procedure is required to make the calculated KLD value be greater than zero at all times since the calculated KLD value is present between a positive value and a negative value around zero. A filtered output value Jₖ⁴ of the KLD value Jₖ³ input to the ARMA filter may be represented as Equation 10. Hereinafter, the filtered output value Jₖ⁴ may be defined as the KLD metric.

$${J}_{k}^{4} = \frac{{τ}_{KLD} - {T}_{s}}{{τ}_{KLD}} {J}_{k - 1}^{4} + \frac{{T}_{s}}{{τ}_{KLD}} ( {J}_{k}^{3} - {J}_{k - 1}^{3} ) . \qquad [ Equation 10 ]$$

In Equation 10, τ_{KLD} denotes a filter time constant (second) and Tₛ denotes a collection interval (one second in the case of the GBAS). Also, as an autoregressive process of the ARMA filter, a first term of Equation 10 blocks or strongly attenuates noise of a high frequency component. A second term of Equation 10 moves a KLD value to be around zero so that a user may easily build a detection criterion regarding whether a system enters an abnormal operating condition, for example, a malfunctioning mode.

A detection threshold T may be calculated based on the filtered output value Jₖ⁴, that is, the KLD metric calculated according to Equation 10 may be represented as Equation 11.

T(el)=μ(el)±K_{ffd}·INF·σ(el) [Equation 11]

In Equation 11, ρ(x) denotes the mean of the KLD metric Jₖ⁴ when an elevation angle is x, σ(x) denotes a standard deviation of the KLD metric when the elevation angle is x, INF denotes an inflation factor based on a heavy-trailed distribution of the KLD metric, and el denotes the elevation angle. Here, constant K_{ffd} may be calculated according to a required probability of false alarm P_{FA}, represented as Equation 12.

K_{ffd}=Q⁻¹(1−P_{FA}/2) [Equation 12]

In Equation 12, Q⁻¹(•) denotes a reverse function of a cumulative probability distribution of a normal distribution.

According to example embodiments, the determiner 120 may compare a detection threshold and a KLD metric. When the KLD metric is greater than the detection threshold as a result of the comparison, the determiner 120 may determine the KLD metric as an anomalous signal.

Also, since a level of noise and an error in a measurement value used to calculate the KLD metric may be subject to the influence of the elevation angle, the detection threshold may be estimated based on the elevation angle.

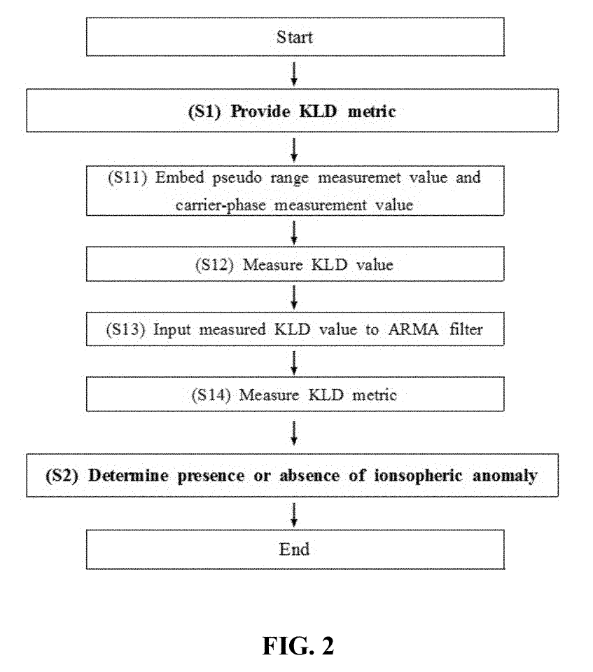

FIG. 2 is a flowchart illustrating an ionospheric anomaly monitoring method using a KLD metric for GBAS according to example embodiments.

Referring to FIG. 2, the ionospheric anomaly monitoring method may include operation S1 of embedding a pseudo range measurement value and a carrier-phase measurement value measured at the GBAS, and providing a KLD metric, and operation S2 of determining a presence or an absence of the ionospheric anomaly using the KLD metric based on the GBAS.

In detail, operation S1 of providing the KLD metric may include operation S11 of embedding the pseudo range measurement value and the carrier-phase measurement value collected from a GPS, operation S12 of measuring a KLD value, and operation S13 of inputting the measured KLD value to an ARMA filter, and operation S14 of measuring the KLD metric.

The KLD metric may match a GBAS in Category (CAT)-II/III service standard according to requirements of an International Civil Aviation Organization (ICAO) standard of the GBAS.

Operation S2 of determining the presence or the absence of the ionospheric anomaly may include comparing a detection threshold and the KLD metric, and determining the KLD metric as an anomalous signal when the KLD metric is greater than the detection threshold.

According to example embodiments, although a required alarm time of the entire GBAS for providing a CAT-1 service is set to 6 seconds, whether a signal is anomalous is to be determined in a GBAS CAT-II/III service. To this end, a variety of methods are proposed. Any method capable of reducing a time-to-flag for detecting an ionospheric anomaly, which is most affecting among integrity threats, may be helpful to design a system for satisfying requirements of the CAT-II/III service.

The units and/or modules described herein may be implemented using hardware components, software components, and/or combination of the hardware components and the software components. For example, the apparatuses and the hardware components described herein may be implemented using, for example, a processor, a controller and an arithmetic logic unit (ALU), a digital signal processor, a microcomputer, a field programmable array (FPA), a programmable logic unit (PLU), a microprocessor, or one or more general-purpose computers or specific-purpose computers such as any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

### Embodiment

To evaluate the performance of an ionospheric anomaly monitoring apparatus using a KLD metric for GBAS, a test evaluation was implemented based on simulation data and real data.

Test Evaluation Based on Simulation Data

Virtual pseudo range pₖ and carrier-phase qₖ signals were created continuously as represented as Equation 13. Here, under the assumption that two signals are diverged at a predetermined gradient based on a data sample of a 1000-th epoch, external noise was applied.

$${p}_{k} = \{ \begin{matrix}8 + {n}_{k} , & 0 < k \leq 1000 \\ 8 + ( k - 1000 ) / 100 + {n}_{k} , & 1000 < k \leq 2000\end{matrix} \\ {q}_{k} = \{ \begin{matrix}4 + {m}_{k} , & 0 < k \leq 2000\end{matrix} \qquad [ Equation 13 ]$$

In Equation 13, each of nₖ and mₖ denotes a measurement value of the applied noise.

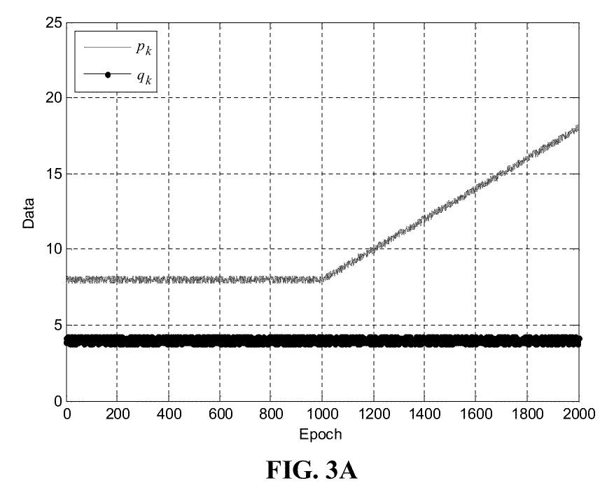

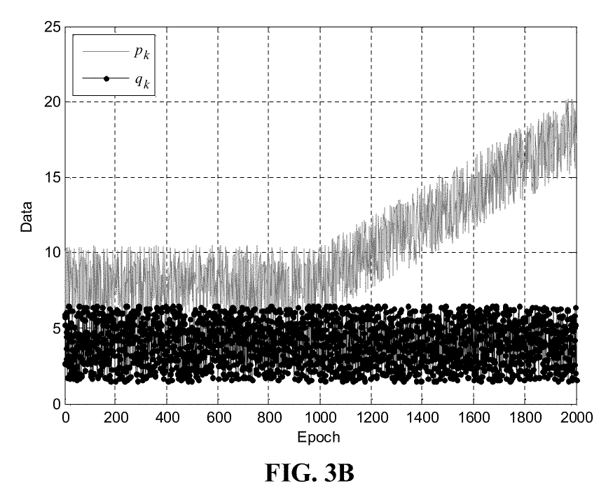

FIGS. 3A and 3B are graphs showing data flows of pₖ and qₖ generated by varying a level of applied noise in a time domain according to example embodiments.

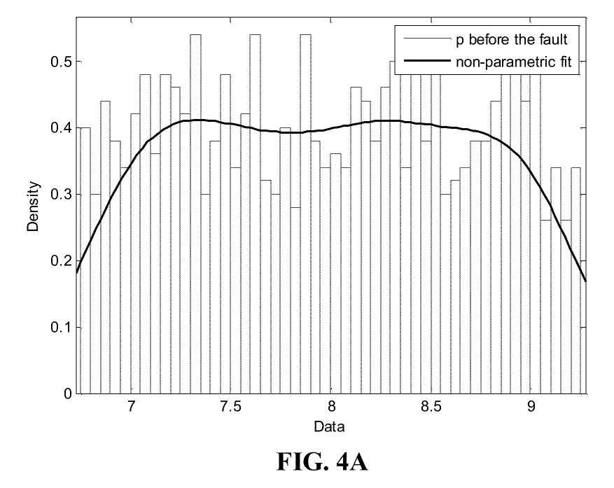

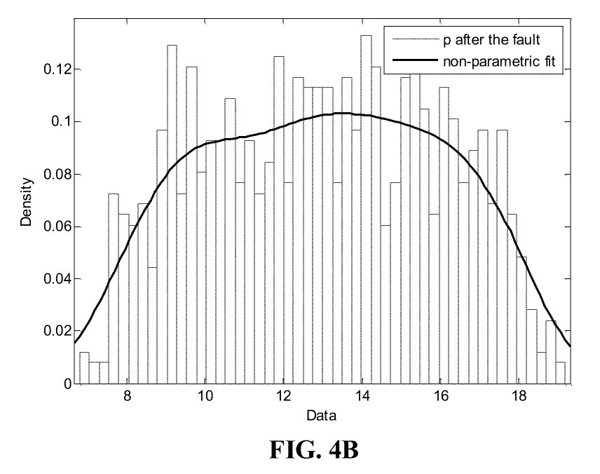

FIG. 4A is a graph showing a data distribution before a 1000-th epoch of pk generated in FIG. 3B, and FIG. 4B is a graph showing a data distribution after a 1000-th epoch of pk generated in FIG. 3B according to example embodiments;

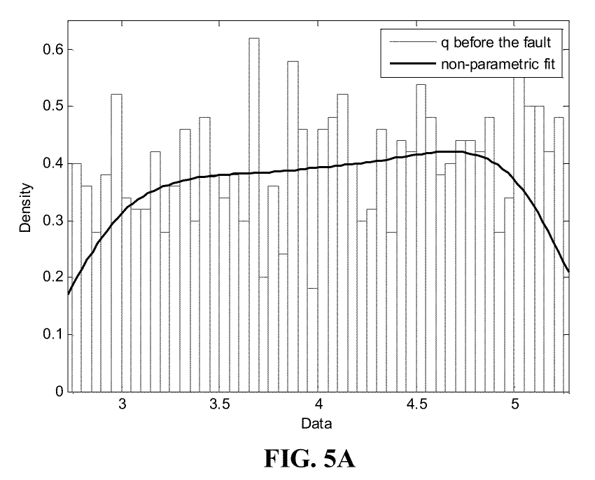

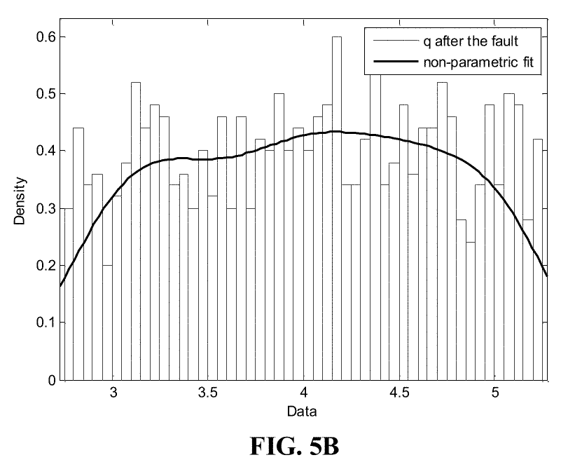

FIG. 5A is a graph showing a data distribution before a 1000-th epoch of qk generated in FIG. 3B, and FIG. 5B is a graph showing a data distribution after a 1000-th epoch of qk generated in FIG. 3B according to example embodiments;

### Embodiment 1—KLD Metric (KLD-1OF) Measurement

The KLD value Jₖ³ was measured according to Equation 8 by embedding data of the pseudo range pₖ and the carrier-phase qₖ, provided as virtual data, to a filter of a KLD anomaly monitoring apparatus using a KLD metric, for example, the ionospheric anomaly monitoring apparatus 100 of FIG. 1. The KLD metric was measured according Equation 10 by inputting the measured KLD value Jₖ³ into the ARMA.

Comparison 1—CCD Metric (CCD-1OF) Measurement

A metric Jₖ was measured according to Equation 2 by embedding data of the pseudo range and the carrier-phase, provided as virtual data, to a filter of a code-carrier divergence (CCD) anomaly monitoring apparatus using a CCD. A CCD metric (CCD-1OF) was measured by inputting the measured metric Jₖ to an ARMA filter.

Comparison 2—CCD Metric (CCD-2OF) Measurement

Aside from measuring a metric Jₖ² according to Equation 4, a CCD metric (CCD-2OF) was measured using the same method as comparison 1.

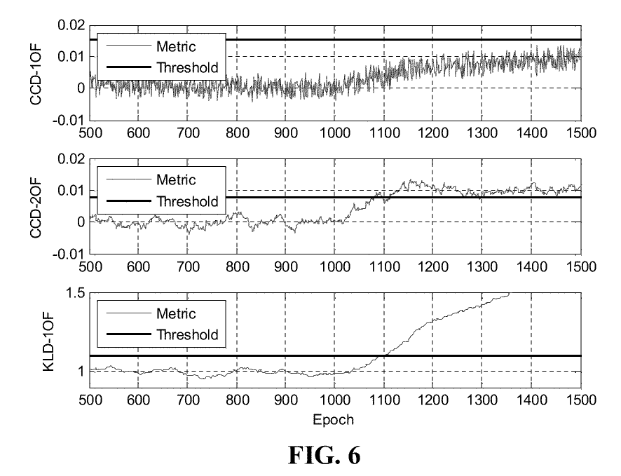

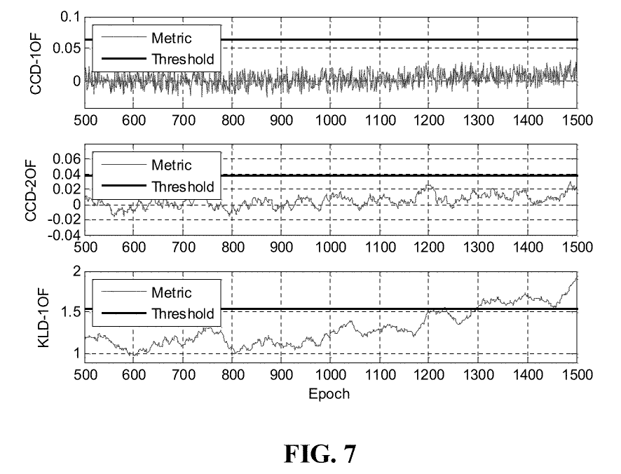

FIGS. 6 and 7 illustrate data flows of the metrics measured in embodiment 1 and comparisons 1 and 2 in a time domain. In FIG. 6, measurement was implemented using data provided in FIG. 2A. In FIG. 7, measurement was implemented using data provided in FIG. 2B. As can be verified from the graphs of FIGS. 6 and 7, the KLD anomaly monitoring apparatus, for example, the ionospheric anomaly monitoring apparatus 100 of FIG. 1, according to embodiment 1 has reached a detection threshold at a relatively fast rate even against relatively great noise as shown in FIG. 7, compared to the CCD anomaly monitoring apparatus according to comparisons 1 and 2.

On the contrary, it can be seen that the CCD anomaly monitoring apparatus according to comparisons 1 and 2 has not reached the detection threshold.

Test Evaluation Based on Real Data

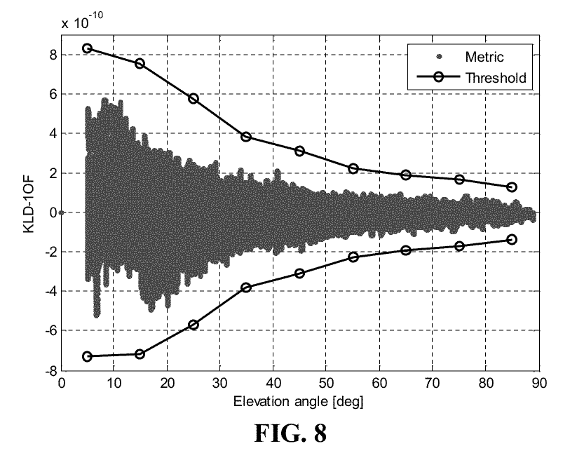

The evaluation test was implemented based on GPS data actually collected in Jeju Airport. FIG. 8 is a graph showing a KLD metric of pseudo range data and carrier-phase data collected based on an elevation angle and a resultant detection threshold according to example embodiments.

An anomalous signal in a lamp form was applied under the assumption of 0.02 m/s ionospheric storm on a specific date based on the data presented in FIG. 8. A result obtained by measuring and analyzing a time-to-flag of the anomalous signal was shown in Table 1. Embodiment 2 (KLD-1OF) was measured using the KLD anomaly monitoring apparatus, for example, the ionospheric anomaly monitoring apparatus 100 of FIG. 1, and comparison 3 (CCD-1OF) and comparison 4 (CCD-2OF) were measured using the CCD anomaly monitoring apparatus.

TABLE 1

| Time-to-flag | Embodiment 2 | Comparison 3 | Comparison 4 |
|---|---|---|---|
| (sec) | KLD-1OF | CCD-1OF | CCD-2OF |
| Mean | 68 | 116 | 105 |
| Standard | 27 | 41 | 53 |
| deviation | | | |

Table 1 shows the mean and the standard deviation obtained from each of the KLD metric calculated according to embodiment 2 and the CCD metrics calculated according to comparisons 3 and 4. As can be seen from Table 1, the mean and the standard deviation of the KLD metric obtained using the KLD anomaly monitoring apparatus of embodiment 2 are less than the mean and the standard deviation of the CCD metrics obtained using the CCD anomaly monitoring apparatus of comparisons 3 and 4. Accordingly, it can be known that the KLD anomaly monitoring apparatus may achieve a significantly fast time-to-flag compared to the CCD anomaly monitoring apparatus.

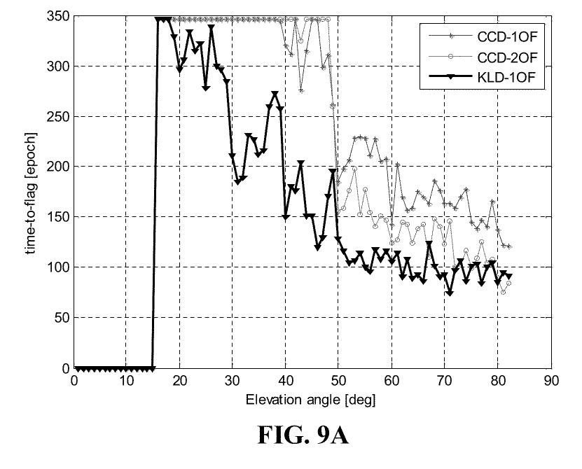

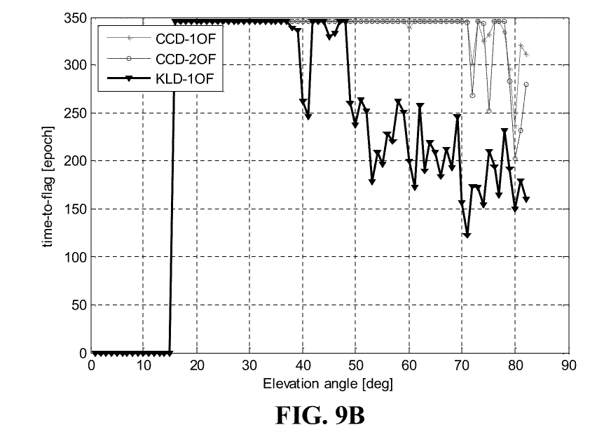

FIGS. 9A and 9B are graphs showing a comparison of a case in which an anomalous signal was applied to a number-24 satellite to compare a time-to-flag with respect to an elevation angle. FIG. 9A is a graph showing a case in which the anomalous signals was applied at a rate of 0.02 m/s, and FIG. 9B is a graph showing a case in which the anomalous signals was applied at a rate of 0.01 m/s.

Referring to FIG. 9A, it can be seen that the KLD anomaly monitoring apparatus according to embodiment 3 (KLD-1OF) exhibited a relatively fast time-to-flag at every elevation angle compared to the CCD anomaly monitoring apparatus according to comparison 5 (CCD-1OF) and comparison 6 (CCD-2OF). Further, referring to FIG. 9B, even when the anomalous signal was applied at a rate of 0.01 m/s, the KLD anomaly monitoring apparatus according to embodiment 3 (KLD-1OF) exhibited a relatively fast time-to-flag at every elevation angle compared to the CCD anomaly monitoring apparatus according to comparison 7 (CCD-1OF) and comparison 8 (CCD-2OF).

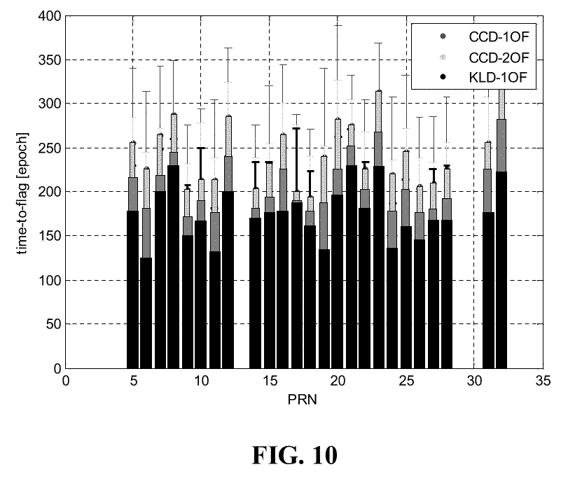

FIG. 10 is a graph showing a comparison of overall average time-to-flag with respect to all of the satellites having appeared based on collected one-day data when a rate of change in the ionospheric gradient is 0.02 m/s. Referring to FIG. 10, it can be seen that the KLD anomaly monitoring apparatus according to embodiment 5 (KLD-1OF) exhibited a relatively enhanced time-to-flag compared to the CCD anomaly monitoring apparatus according to comparison 7 (CCD-1OF) and comparison 8 (CCD-2OF).

Although a few example embodiments of the present disclosure have been shown and described, the present disclosure is not limited to the described example embodiments. Instead, it would be appreciated by those skilled in the art that changes may be made to these embodiments without departing from the principles and spirit of the invention, the scope of which is defined by the claims and their equivalents.

What is claimed is:

1. An apparatus for monitoring an ionospheric anomaly for a ground-based augmentation system (GBAS) ground system, the apparatus comprising:
a filter configured to embed a pseudo range measurement value and a carrier-phase measurement value measured at the GBAS, and to provide a Kullback-Leibler divergence (KLD) metric; and
a determiner configured to determine a presence or an absence of the ionospheric anomaly using the KLD metric for GBAS.

2. The apparatus of claim 1, wherein the filter is an auto-regressive moving average (ARMA) filter.

3. The apparatus of claim 1, wherein the KLD metric matches a GBAS in Category (CAT)-II/III service standard according to requirements of an International Civil Aviation Organization (ICAO) standard of the GBAS.

4. The apparatus of claim 1, wherein the determiner is further configured to compare a detection threshold and the KLD metric, and to determine the KLD metric as an anomalous signal in response to the KLD metric being greater than the detection threshold.

5. The apparatus of claim 1, wherein the filter is further configured to phase-shift the embedded pseudo range measurement value and carrier-phase measurement value according to Equation 6 and Equation 7, respectively, and to calculate a KLD value based on the phase-shifted pseudo range measurement value and carrier-phase measurement value according to Equation 8:
$$\begin{matrix}{ξ}_{ρ , k} = {[ {ρ}_{k} , {ρ}_{k - {T}_{s}} , … , {ρ}_{k - ( L - 1 ) {T}_{s}} ]}^{T} ∈ Γ ⋐ {L}^{} & [ Equation 6 ] \\ {ξ}_{φ , k} = {[ {φ}_{k} , {φ}_{k - {T}_{s}} , … , {φ}_{k - ( L - 1 ) {T}_{s}} ]}^{T} ∈ Θ ⋐ {L}^{} , and & [ Equation 7 ] \\ {J}_{k}^{3} = \sum f ( {ξ}_{ρ , k} ) log \frac{f ( {ξ}_{ρ , k} )}{g ( {ξ}_{φ , k} )} , & [ Equation 8 ]\end{matrix}$$
where ρₖ denotes a pseudo range, φₖ denotes a carrier-phase, ξ_{ρ,k} denotes the phase-shifted pseudo range, ξ_{φ,k} denotes the phase-shifted carrier-phase measurement value, and Jₖ³ denotes the KLD value.

6. The apparatus of claim 5, wherein the KLD metric is obtained according to Equation 10:
$${J}_{k}^{4} = \frac{{τ}_{KLD} - {T}_{s}}{{τ}_{KLD}} {J}_{k - 1}^{4} + \frac{{T}_{s}}{{τ}_{KLD}} ( {J}_{k}^{3} - {J}_{k - 1}^{3} ) . \qquad [ Equation 10 ]$$

7. The apparatus of claim 4, wherein the detection threshold is obtained according to Equation 11:
T(el)=μ(el)±K_{ffd}·INF·σ(el), [Equation 11]
where μ(x) denotes the mean of the KLD metric Jₖ⁴ when an elevation angle is x, σ(x) denotes the standard deviation of the KLD metric when the elevation angle is x, INF denotes an inflation factor based on a heavy-tailed distribution of the KLD metric, el denotes the elevation angle, and K_{ffd} denotes a constant and is represented as Equation 12:
K_{ffd}=Q⁻¹(1−P_{FA}/2), [Equation 12]
where Q⁻¹(•) denotes a reverse function of a cumulative probability distribution of a normal distribution.

8. A method of monitoring an ionospheric anomaly based on a ground-based augmentation system (GBAS) ground system, the method comprising:
embedding a pseudo range measurement value and a carrier-phase measurement value measured at the GBAS, and providing a Kullback-Leibler divergence (KLD) metric; and
determining a presence or an absence of the ionospheric anomaly using the KLD metric based on the GBAS.

9. The method of claim 8, wherein the providing of the KLD metric comprises using an auto-regressive moving average (ARMA) filter, and
the KLD metric matches a GBAS in Category (CAT)-II/III service standard according to requirements of an International Civil Aviation Organization (ICAO) standard of the GBAS.

10. The method of claim 8, wherein the determining of the presence or the absence of the ionospheric anomaly comprises comparing a detection threshold and the KLD metric, and determining the KLD metric as an anomalous signal in response to the KLD metric being greater than the detection threshold.

11. A non-transitory computer-readable medium storing a program to implement the method of claim 8.
